(19) United States
(12) Patent Application Publication
(10) Pub. No.: US 2010/0107489 A1
(43) Pub. Date: May 6, 2010

(54) ADJUSTABLE PLANT STAND

(76) Inventor: Norman Silver, Willow Grove, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/606,706

(22) Filed: Oct. 27, 2009

Related U.S. Application Data
(63) Continuation of application No. 12/404,109, filed on Mar. 13, 2009, now abandoned.
(60) Provisional application No. 61/036,618, filed on Mar. 14, 2008.

(51) Int. Cl. A01G 9/00; A01G 1/00; F21S 4/00

(52) U.S. Cl. 47/39; 47/58.1 R; 362/249.01

(57) ABSTRACT

An adjustable plant growing stand, a mounting clip for attaching a lighting fixture to an adjustable plant growing stand, and a method of illuminating plants are disclosed. The adjustable plant growing stand can include a frame including a plurality of substantially parallel legs, an upper fixed shelf affixed to the legs, and a lower adjustable shelf slidably coupled to the legs. The lower adjustable shelf can include attachment mechanisms configured to fix the vertical height of the lower adjustable shelf relative to the upper fixed shelf. The adjustable plant growing stand can include a lighting assembly including one or more lighting fixtures. Each lighting fixture can include a plant growth-stimulating light source. Each lighting fixture can be removably coupled to the upper fixed shelf.

### CROSS-REFERENCE TO RELATED APPLICATIONS

This application claims priority under 35 U.S.C. §119(e) to U.S. Provisional Patent Application No. 61/036,618, filed on Mar. 14, 2008 and entitled “Adjustable Plant Stand,” which is herein incorporated by reference in its entirety.

### TECHNICAL FIELD

The present invention relates generally to a plant growth apparatus. More specifically, the invention relates to plant growing stands having an adjustable shelf which accommodates plant growth.

### BACKGROUND

Plant growing stands that include grow lights are commonly used in many environments, including nurseries and private homes. Conventional plant growing stands that include grow lights can include shelves and grow lights at fixed locations. Such conventional plant growing stand designs can be suboptimal during portions of the life of a particular plant, because the top of the plant can be positioned too close or too far away from the grow light at various points in time.

Some conventional plant growing stands include adjustable height grow lights that can be suspended above plants on a fixed shelf. Such adjustable height grow lights can be raised or lowered to maintain a desired distance between the top of the plants and the bottom of the grow lights as the plant grows. However, the adjustable height grow lights in such designs may not be integrated into the design of the plant growing stand, and such plant growing stands can be easy to damage and unattractive.

There is a need for an improved plant growing stand that can maintain growth lights at an optimal distance to the top of plants.

### SUMMARY

An adjustable plant growing stand, a mounting clip for attaching a lighting fixture to an adjustable plant growing stand, and a method of illuminating plants are disclosed. The adjustable plant growing stand can include a frame including a plurality of substantially parallel legs, an upper fixed shelf affixed to the legs, and a lower adjustable shelf slidably coupled to the legs. The lower adjustable shelf can include attachment mechanisms configured to fix the vertical height of the lower adjustable shelf relative to the upper fixed shelf. The adjustable plant growing stand can include a lighting assembly including one or more lighting fixtures. Each lighting fixture can include a plant growth-stimulating light source. Each lighting fixture can be removably coupled to the upper fixed shelf.

### BRIEF DESCRIPTION OF THE DRAWINGS

The present technology provides an adjustable plant growing stand and related methods for making and using the adjustable plant growing stand. The technology will now be described in more detail, by way of example only, with reference to the accompanying drawings, in which:

FIG. 1A is a perspective view of an adjustable plant growing stand according to a first embodiment of the invention;

FIG. 1B is a front view of the adjustable plant growing stand depicted in FIG. 1A, oriented parallel to the longitudinal axis of the grow light fixtures;

FIG. 1C is a side view of the adjustable plant growing stand depicted in FIG. 1A, oriented perpendicular to the longitudinal axis of the grow light fixtures;

FIG. 2A is a diagrammatic perspective view of a frame assembly including an adjustment mechanism, wherein the frame assembly is suitable for use in the adjustable plant growing stand depicted in FIG. 1A;

FIG. 2B is a side view of a shelf anchor member suitable for use in the adjustable plant growing stand depicted in FIG. 1A;

FIG. 2C is a top view of the shelf anchor member depicted in FIG. 2B;

FIG. 2D is an enlarged perspective view of the adjustment mechanism depicted in FIG. 2A.

FIG. 3A is a top perspective view of a grow light fixture assembly including an electrical coupling, wherein the grow light fixture assembly is suitable for use in the adjustable plant growing stand depicted in FIG. 1A;

FIG. 3B is a bottom perspective view of the grow light fixture assembly depicted in FIG. 3A;

FIG. 3C is a perspective view of the electrical coupling depicted in FIG. 3A;

FIG. 4A is a perspective view of a grow light fixture clip suitable for use in the adjustable plant growing stand depicted in FIG. 1A;

FIG. 4B is a front plan view of the grow light fixture clip depicted in FIG. 4A;

FIG. 4C is a side plan view of the grow light fixture clip depicted in FIG. 4B;

FIG. 4D is a top plan view of the grow light fixture clip depicted in FIG. 4C;

FIG. 5A is a perspective view of a drip tray suitable for use in the adjustable plant growing stand depicted in FIG. 1A; and

FIG. 5B is a perspective view of the coupling portion of a shelf panel suitable for use in the adjustable plant growing stand depicted in FIG. 1A; and

FIG. 6 is a perspective view of an adjustable plant growing stand according to a second embodiment of the invention.

### DETAILED DESCRIPTION OF ILLUSTRATIVE EMBODIMENTS

The embodiments described below provide an adjustable plant growing stand and related methods for making and using the adjustable plant growing stand. The embodiments described below illustrate several aspects of the present inventions and are not intended to be limiting. The embodiments can find utility in an indoor environment where the grow lights (e.g., fluorescent lights, ultraviolet lights, LEDs, etc.) of the inventive plant growing stand are useful to provide illumination which stimulates the growth of plants.

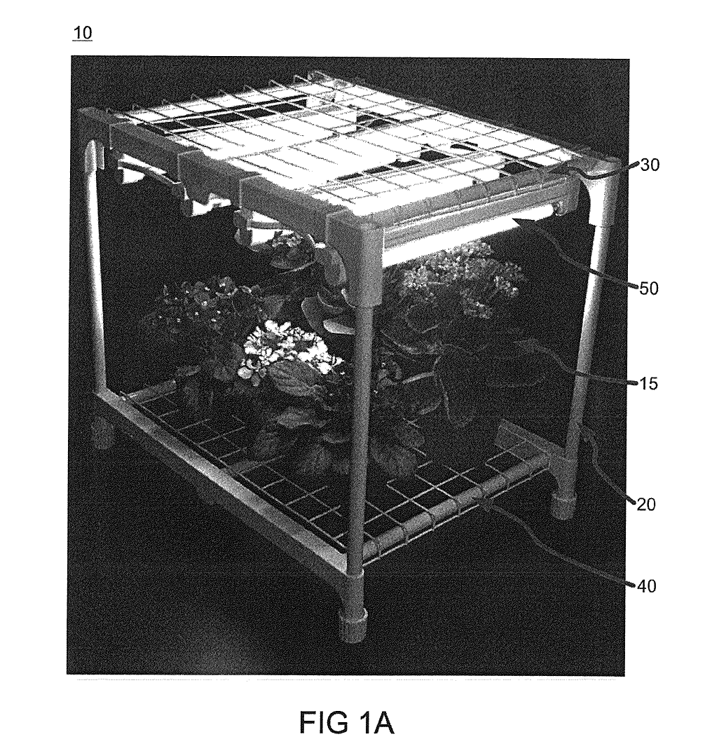

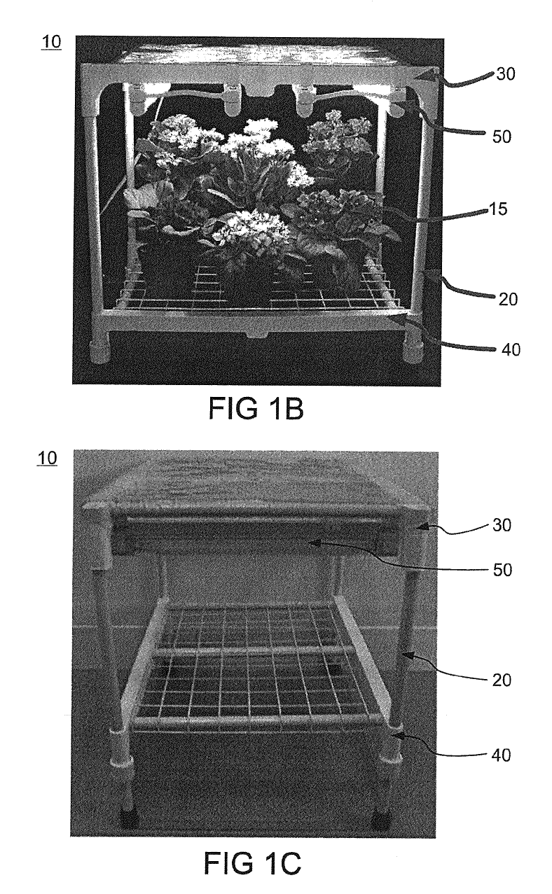

Referring to FIGS. 1A-1C, an adjustable plant growing stand 10 includes a frame assembly 20 and a lighting assembly 50. The frame assembly 20 includes an upper fixed shelf 30 and a lower adjustable shelf 40. The frame assembly 20 can be of the type commercially available, for example, under model number SH3221 A-D (99744) or SH3221-D-LARGE (99764), from Shang Huei Enterprise Co., Ltd., located in Guangdong, China. The lighting assembly 50 is removably coupled to the upper fixed shelf 30. The adjustable plant growing stand 10 is configured to carry plants or seedlings 15.

The adjustable plant growing stand 10 can be suitable for growing plants 15, such as plants under approximately two feet tall. Although plants 15 having a height of approximately two feet are shown in FIG. 1A, plants 15 of any height can be placed in an adjustable plant growing stand 10 of an appropriate relative size and adjustment range.

The plants 15 are located on the lower adjustable shelf 40 underneath the lighting assembly 50. The lower adjustable shelf 40 can be lowered away from the lighting assembly 50 as the plants 15 grow taller. By lowering the lower adjustable shelf 40, a user can maintain a desired distance or “head room” between the tops of the plants 15 and the bottom of the lighting assembly 50 positioned above the plants 15. In one embodiment, the head room between the tops of the plants 15 and the bottom of the lighting assembly 50 is between approximately 1 inch and approximately 6 inches, for example, approximately 3 inches, though any desired head room is contemplated. The vertical range of adjustment of the lower adjustable shelf 40 can be any distance that permits the top of the plants 15 of the desired size to be maintained within the optimal distance to the bottom of the lighting assembly 50 as the plants 15 grow throughout their life cycle.

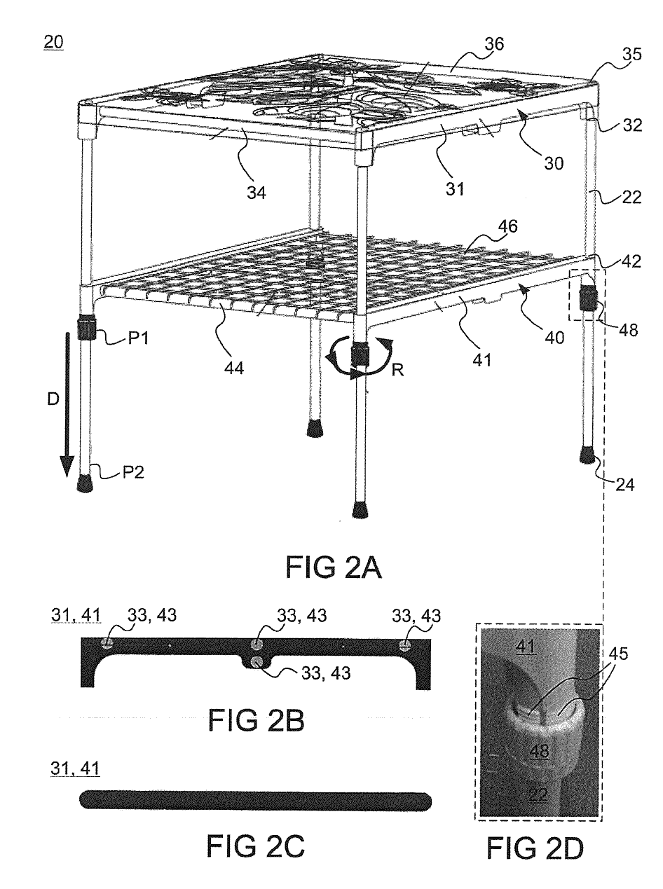

Referring to FIGS. 2A-2C, the frame assembly 20 further includes a plurality of legs 22. The legs 22 can be replaced with longer or shorter legs 22 to allow the overall height of the adjustable plant growing stand 10 to be adjusted. Each leg 22 includes a foot 24 that can be constructed from rubber or another material that can prevent the legs 22 from scratching the surface upon which the stand 10 rests and/or absorb small height differences between the legs 22 to keep the frame assembly 20 level. Although four legs 22 are shown in FIG. 2A, any number of legs 22 can be used. For example, six legs 22 can be used, with three legs 22 located on each side of the frame assembly 20.

The upper fixed shelf 30 includes two shelf anchor members 31 and three connector members 34. A shelf panel 36 can be overlaid on the upper fixed shelf 30 or coupled to the connector members 34 of the upper fixed shelf 30. As shown in FIG. 2B, each shelf anchor member 31 includes two leg recesses 32 for coupling to the top of respective legs 22, four connector recesses 33 for coupling to the ends of respective connector members 34, and two stacking recesses 35 for elective coupling to the ends of the legs 22 of a second frame assembly 20. The two horizontally oriented shelf anchor members 31 and the three horizontally oriented connector members 34 form the structure of the upper fixed shelf 30 when assembled.

The coupling mechanism between each leg 22 and the respective leg recess 32 can be a press-fit between the leg 22 and the leg recess 32 (so that, for example, the stand 10 can be easily assembled for use and disassembled for storage), or the coupling mechanism can be glue, welding, or any other coupling mechanism that is known in the art. The coupling mechanism between each connector members 34 and the respective connector recesses 33 can be a press-fit between the connector member 34 and the connector recesses 33, glue, welding, or any other coupling mechanism that is known in the art.

As shown in the Figures, each leg recess 32 does not fully penetrate through the shelf anchor member 31. In other embodiments, each leg recess 32 can fully penetrate through the shelf anchor member 31, and a mechanism (such as the adjustment mechanism 48) can be used to fix the vertical location of the upper fixed shelf 30 relative to the legs 22.

The stacking recesses 35 can be used to stack multiple frame assemblies 20 on top of each other. The stacking recesses 35 are upward facing recesses in the top surface of the shelf anchor members 31 above the leg recesses 32. The stacking recesses 35 of a first frame assembly 20 can accommodate the insertion of the legs 22 of a second frame assembly 20 to be placed on top of the first frame assembly 20. In order to insert the legs 22 of a second frame assembly 20 into the stacking recesses 35 of the first frame assembly 20, the feet 24 can be removed from the legs 22 of the second frame assembly 20. When not in use to accommodate a second frame assembly 20, the stacking recesses 35 can be capped or plugged.

The lower adjustable shelf 40 includes two shelf anchor members 41 and three connector members 44. One or more shelf panels 46 can be overlaid on the lower adjustable shelf 40 and/or coupled to the connector members 44. As shown in FIG. 2B, each shelf anchor member 41 includes two leg apertures 42 for slidably coupling to the respective legs 22, four connector recesses 43 for coupling to the ends of respective connector members 44, and two adjustment mechanisms 48 for selectively adjusting the vertical position of the shelf anchor member 41 at a particular position along the respective legs 22. The two horizontally oriented shelf anchor members 41 and the three horizontally oriented connector members 44 form the structure of the lower adjustable shelf 40 when assembled.

Each leg aperture 42 is sized relative to the diameter of a respective leg 22 such that the leg aperture 42 can be vertically slid along the leg 22 by a user, downward in a direction D or upward in a direction opposite that of the direction D. For example, a user can position the lower adjustable shelf 40 in an initial position P1, and when plants have grown larger, a user can slide the lower adjustable shelf 40 to a final position P2 by sliding the leg apertures 42 down the respective legs 22. Each leg aperture 42 can be slightly smaller than the diameter of a respective leg 22 to result in a press-fit between the leg aperture 42 and the respective leg 22, or each leg aperture 22 can be slightly larger than the diameter of a respective leg 22 to allow the leg aperture 42 to freely slide along the respective leg 22.

As shown in FIGS. 2A and 2D, the adjustment mechanisms 48 are cylindrical tapped compression or tightening knobs that allows the user to selectively adjust the vertical position of the shelf anchor member 41. As shown in FIG. 2D, the tapped adjustment mechanisms 48 can be screwed onto tapered threaded fingers 45 extending downward from the bottom of the shelf anchor member 41. Each finger 45 extends circumferentially around a portion of the leg aperture 42. As the adjustment mechanism 48 is rotated, the adjustment mechanism 48 compresses the fingers 45 against the leg 22, which increases the force applied by the fingers 45 against the leg 22 until the friction force between the fingers 45 and the leg 22 is sufficiently high to fix the lower adjustable shelf 40 in a desired position, for example, initial position P1 or final position P2.

In other embodiments, the adjustment mechanisms 48 can be a thumbscrew mechanism, a molded detent and corresponding tab combination, a hole and pin combination, a preset notch and groove combination, or any other mechanism that can selectively adjust the vertical position of the shelf anchor member 41. The adjustment mechanisms 48 can be knurled on the outside surface so that a user can easily grip the outside surface to tighten or loosen the adjustment mechanisms 48.

Although four connector recesses 33 or 43 are shown in FIG. 2B, in some embodiments, one or more of the connector recesses 33 or 43 can be left vacant. For example, in the first embodiment adjustable plant growing stand shown in FIGS. 1A-1C, three connector members 34 or 44 are positioned in three respective pairs of connector recesses 33 or 43 between opposing shelf anchor members 31 or 41, and the fourth connector recess 33 or 43 (the connector recess 33 or 43 that is the lower of the two connector recesses 33 or 43 in the center of the shelf anchor member 31 or 41) is left vacant. In other embodiments, a fourth connector member 34 or 44 can be positioned in the fourth pair of connector recess 33 or 43 to provide additional support for the shelf panel 36 or 46.

The shelf panels 36 and 46 are substantially flat sheet-like panels supported by respective connector members 34 and 44. The shelf panels 36 and 46 provide a surface on which to place plants 15 (the shelf panel 46) or gardening accessories such as a small watering can, fertilizer, seeds, small flower pots, cultivation tools, and the like (the shelf panel 36). As shown in FIG. 2A, the shelf panel 36 can be a solid translucent thermoform plastic molding sheet, or the shelf panel 46 can be a metal mesh sheet. In other embodiments, the shelf panels 36 and 46 can be made from any combination of translucent or opaque materials such as any plastic, polymer, composite, glass, ceramic, wood, wood by-products, wood-like products, metal, or any other material known in the art that is suitable for use as a shelf.

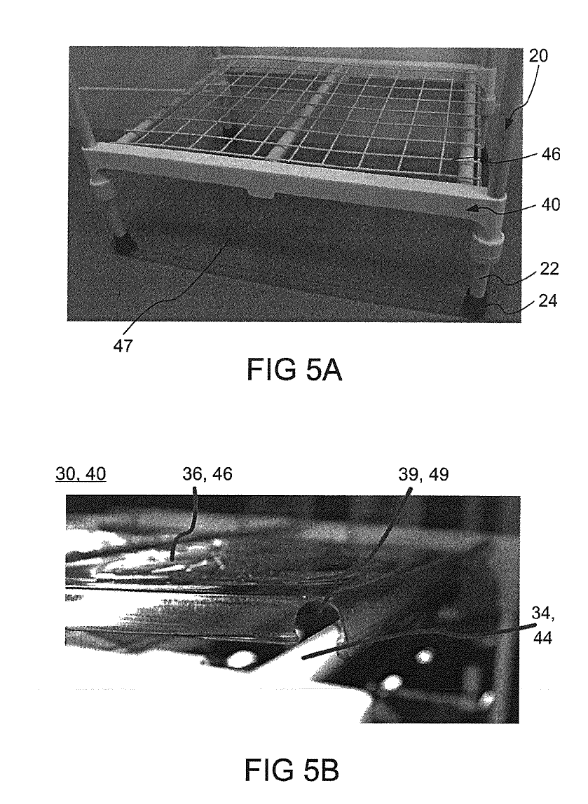

In some embodiments, there can be two shelf panels 46, including, for example, a metal mesh panel overlaying the lower adjustable panel 40 to support plants 15 and a solid plastic panel coupled to the connector members 44 to serve as a drip tray to catch water that may drip off of and/or around the plants 15. In some embodiments, for example, as shown in FIG. 5A, the drip tray 47 can placed under the feet 24 of the legs 22 of the frame assembly 20.

In an exemplary embodiment, the various structural components of the frame 20, including the legs 22, the shelf anchor members 31 and 41, the connector members 34 and 44, and the adjustment mechanisms 48 are made from plastic. However, in other embodiments, the various structural components of the frame 20 can be made of any combination of materials such as any plastic, polymer, composite, glass, ceramic, wood, wood by-products, wood-like products, metal, or any other material known in the art that is suitable for use as a structural component of a plant stand frame.

In some embodiments (not shown), multiple lower adjustable shelves 40 can be included in a single frame assembly 20. In such embodiments, each lower adjustable shelf 40 can be assembled onto the legs 22, and each adjustable shelf 40 can be slid along the legs 22 independently from the other adjustable shelf 40.

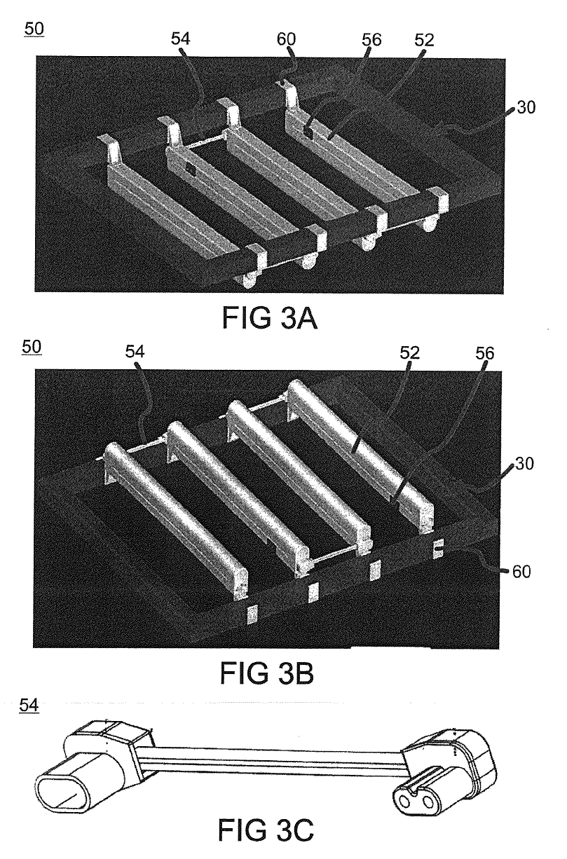

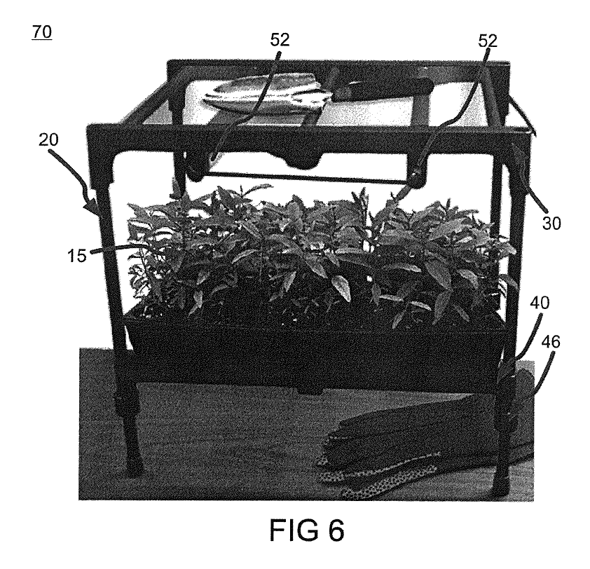

Referring to FIGS. 3A-3C, the lighting assembly 50 includes one or more lighting fixtures 52, one or more electrical connection cords 54 for electrically coupling the lighting fixtures 52, and one or more pairs of mounting clips 60 for removably coupling the lighting fixtures 52 to the shelf anchor members 31 of the upper fixed shelf 30 of the frame assembly 20. As shown in FIGS. 3A and 3B, the lighting assembly 50 includes four lighting fixtures 52. In other embodiments, such as the second embodiment adjustable plant growing stand 70 shown in FIG. 6, the lighting assembly 50 can include any number of lighting fixtures 52, including, for example, one, two, three, four, six, or eight lighting fixtures 52.

Each lighting fixture 52 includes one or more conventional plant growth-stimulating light sources such as fluorescent lamps, ultraviolet (UV) lamps, LED lamps, grow light spectrum lamps, incandescent lamps, “black-light” lamps, or any other growth-stimulating light source known in the art. In exemplary embodiments, the lighting fixtures 52 are T5 size T58W or T514W lamps.

Each lighting fixture 52 includes a light actuation switch 56 that enables each lighting fixture 52 to be turned on or off independently of the other lighting fixtures 52. Accordingly, any individual lighting fixture 52 can be illuminated independently from the other lighting fixtures 52.

The electrical connection cords 54 link the lighting fixtures 52 together in a series or daisy chain fashion. Accordingly, a single AC supply cord can provide AC power to all of the lighting fixtures 52 via the electrical connection cords 54. The electrical connection cords 54 can permit a user to easily interconnect conventional lighting fixtures 52 to a single AC power source. In other embodiments, each lighting fixture 52 can have a separate power source (e.g., an included battery). In such embodiments, the electrical connection cords 54 can be omitted.

Each mounting clip 60 is coupled on a first side to a shelf anchor member 31 of the upper fixed shelf 30 of the frame assembly 20 and on a second side to a respective lighting fixture 52, such that each lighting fixture 52 is suspended between the two shelf anchor members 31 above the lower adjustable shelf 40.

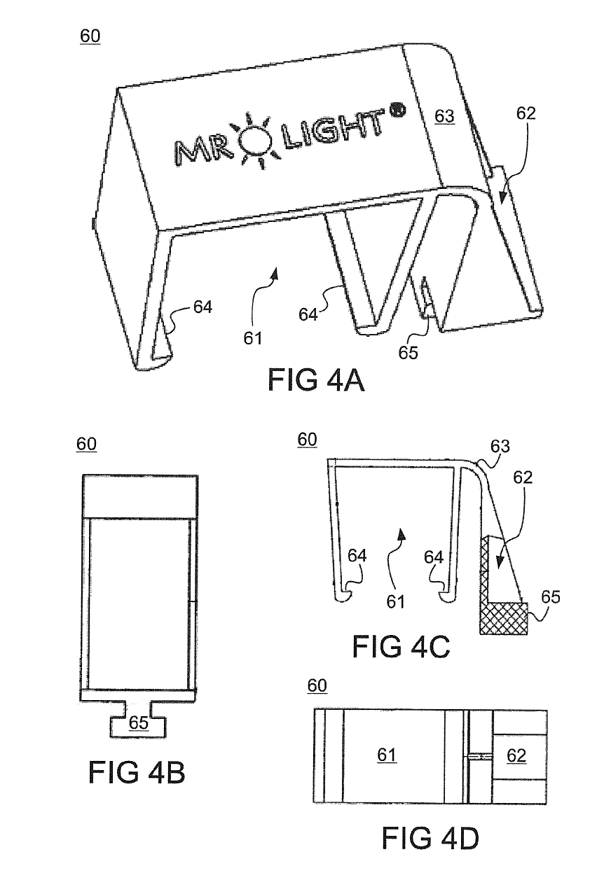

Referring to FIGS. 4A-4D, the mounting clip 60 includes a first frame coupling portion 61 for attachment to a shelf anchor member 31 of an upper fixed shelf 30, a second light coupling portion 62 for attachment to a lighting fixture 52, and a third connecting portion 63 that joins the first and second coupling portions 61 and 62. The first frame coupling portion 61 includes one or more tabs 64 for retaining the mounting clip 60 onto the shelf anchor member 31 after installation of the mounting clip 60. The second light coupling portion 62 includes a T-shaped protrusion 65 for slideably coupling to a corresponding slot in the top surface of a conventional lighting fixture 52.

As shown in FIG. 4A, the first frame coupling portion 61 is adapted to be clipped or clamped to a shelf anchor member 31 having a substantially rectangular cross sectional shape. However, in other embodiments, the first frame coupling portion 61 can be adapted to be clipped to a shelf anchor member 31 having any cross sectional shape, including round, hexagonal, or any other cross sectional shape. Although the first frame coupling portion 61 is shown in FIG. 4A as having a clip shape, the attachment of the lighting fixtures 52 to the shelf anchor members 31 can be accomplished by other attachment mechanisms, including, for example, a notch and groove, a pin, a screw, a hook and loop fastener, or any other suitable attachment mechanism that is known in the art.

Third connecting portion 63 can be a curved, flexible spring element extending between the first frame coupling portion 61 and the second light coupling portion 62, thereby allowing a user to attach and remove the lighting fixtures 52 to the shelf anchor members 31 without breaking the mounting clips 60.

In an exemplary embodiment, the mounting clips 60 are made of a flexible acetal plastic material “POM” polyoxymethylene. In other embodiments, other materials can be used for the mounting clips 60, including, for example, any type of plastic, rubber, metal, wood, nylon, or any other suitable material or combination of materials known in the art.

Referring to FIG. 5A, a drip tray 47 can be positioned underneath the legs 22 of the frame assembly 20. In such embodiments including a drip tray 47 positioned underneath the legs 22 of the frame assembly 20, the drip tray 47 can be placed around the feet 24 of the legs 22. The sidewalls of the drip tray 47 can be press-fit against the outside of the feet 24 (e.g., wherein area of the panel of the drip tray 47 is equal to or slightly smaller than the area bounded by the outside of the feet 24), or the feet 24 can be loosely placed against the inside of the sidewalls of the trip tray 47 (e.g., wherein the area of the panel of the drip tray 47 is slightly larger than the area bounded by the outside of the feet 24).

Referring to FIG. 5B, the shelf panel 36 or 46 can include a coupling notch 39 or 49 on each side of the shelf panel 36 or 46 for coupling the respective side of the shelf panel 36 or 46 to a connecting member 34 or 44. As shown in FIG. 5B, the coupling notch 39 or 49 can be snapped onto a connecting member 34 or 44 by a user positioning the shelf panel 36 or 46 over the respective shelf 30 or 40 and pressing the coupling notch 39 or 49 down onto the connecting member 34 or 44. In embodiments including a drip tray coupled to the lower adjustable shelf 40, a second drip tray shelf panel 46 can be snapped to the underside of the lower adjustable shelf 40 by pressing the coupling notches 49 up onto the respective connecting members 44.

Referring to FIG. 6, a second embodiment adjustable plant growing stand 70 includes plants or seedlings 15, a frame assembly 20 including an upper fixed shelf 30 and a lower adjustable shelf 40, and two lighting assemblies 52.

The present invention has been illustrated by the description of several embodiments. The present invention, however, is not limited to the particular embodiments described herein. Rather, the present invention encompasses any combination of the features of any of the embodiments and natural variations thereof, as will be understood by persons familiar with plant stand technology.

What is claimed:

1. An adjustable plant growing stand, comprising:
a frame including a plurality of substantially parallel legs, an upper fixed shelf affixed to the legs, and a lower adjustable shelf slidably coupled to the legs, the lower adjustable shelf including attachment mechanisms configured to fix the vertical height of the lower adjustable shelf relative to the upper fixed shelf;
a lighting assembly including one or more lighting fixtures, each lighting fixture including a plant growth-stimulating light source, each lighting fixture removably coupled to the upper fixed shelf.

2. The stand of claim 1, wherein the lighting fixtures illuminate downward from a lower side of the upper fixed shelf.

3. The stand of claim 1, wherein the lighting assembly further includes one or more electrical connection cords that are electrically connected between a first lighting fixture and a second lighting fixture, such that the first and second lighting fixtures can be powered by a single AC source.

4. The stand of claim 1, wherein each lighting fixture includes a light actuation switch that is configured to selectively direct power to the lighting fixture.

5. The stand of claim 1, wherein the upper fixed shelf further includes stacking apertures adapted to receive the legs of a second frame positioned above the upper fixed shelf.

6. The stand of claim 1, wherein each of the upper fixed shelf and the lower adjustable shelf further includes a shelf panel.

7. The stand of claim 6, wherein the lower adjustable shelf further includes a drip tray.

8. The stand of claim 1, wherein the lighting assembly further comprises a plurality of mounting clips, each clip comprising:
a first portion having sides and a retaining mechanism adapted to removably couple the clip to a shelf anchor member of the upper fixed shelf; and
a second portion having a T-shaped protrusion adapted to slideably couple to a first lighting fixture via insertion into a corresponding slot in the top surface of the first lighting fixture;
wherein, when attached to the first lighting fixture and the shelf anchor member, the clip provides structural support for the first lighting fixture, the clip supporting the first lighting fixture at a position below a plane established by the bottom surface of the upper fixed shelf.

9. The stand of claim 8, wherein the first portion of the clip comprises one of a circular cross-section and a rectangular cross section.

10. The stand of claim 8, wherein the clip further includes a tab to retain the clip onto the shelf anchor member after installation.

11. The stand of claim 8, further comprising a flexible spring element located between the first portion and the second portion.

12. A mounting clip for attaching a lighting fixture to an adjustable plant growing stand, the clip comprising:
a first portion having sides and a retaining mechanism adapted to removably couple the clip to a shelf anchor member of the adjustable plant growing stand; and
a second portion having a T-shaped protrusion adapted to slideably couple to the lighting fixture via insertion into a corresponding slot in the top surface of the lighting fixture;
wherein, when attached to the lighting fixture and the shelf anchor member, the clip provides structural support for the lighting fixture, the clip supporting the lighting fixture at a position below a plane established by the bottom surface of the shelf anchor member.

13. The clip of claim 12, wherein the first portion of the clip comprises one of a circular cross-section and a rectangular cross section.

14. The clip of claim 12, wherein the clip further includes a tab to retain the clip onto the shelf anchor member after installation.

15. The clip of claim 12, further comprising a flexible spring element located between the first portion and the second portion.

16. A method of illuminating plants, comprising:
placing a plant having a first height onto an adjustable plant growing stand at a first time, the stand including an upper fixed shelf affixed to a plurality of substantially parallel legs and a lower adjustable shelf slidably coupled to the legs, the lower adjustable shelf being disposed at an initial position;
illuminating the plant by turning on a lighting assembly, the lighting assembly including one or more lighting fixtures, each lighting fixture including a plant growth-stimulating light source and removably coupled to the upper fixed shelf;
lowering the plant away from the lighting assembly at a second time by releasing an adjustment mechanism coupled to the lower adjustable shelf and sliding the lower adjustable shelf down relative to the upper fixed shelf, the second time being after the plant has grown taller to have a second height larger than the first height, the lower adjustable shelf being disposed at a final position lower than the initial position.
fixing the lower adjustable shelf at the final position by tightening the adjustment mechanism that tightens the lower adjustable shelf to the plurality of substantially parallel legs.

17. The method of claim 16, further comprising placing the legs of a second adjustable plant growing stand into stacking apertures located in the upper fixed shelf, the second adjustable plant growing stand positioned above the upper fixed shelf.

18. The method of claim 16, wherein the lighting assembly further includes one or more electrical connection cords that are electrically connected between a first lighting fixture and a second lighting fixture, such that the first and second lighting fixtures can be powered by a single AC source.

19. The method of claim 16, wherein the lower adjustable shelf further includes a drip tray.

20. The method of claim 16, wherein each lighting fixture is removably coupled to the upper fixed shelf using mounting clips, each clip comprising:
a first portion having sides and a retaining mechanism adapted to removably couple the clip to a shelf anchor member of the upper fixed shelf; and
a second portion having a T-shaped protrusion adapted to slideably couple to the lighting fixture via insertion into a corresponding slot in the top surface of the lighting fixture;
wherein, when attached to the lighting fixture and the shelf anchor member, the clip provides structural support for the lighting fixture, the clip supporting the lighting fixture at a position below a plane established by the bottom surface of the upper fixed shelf.
